(19) United States
(12) Patent Application Publication
(10) Pub. No.: US 2022/0293039 A1
(43) Pub. Date: Sep. 15, 2022

(54) METHOD AND DEVICE FOR IMPROVING GRADIENT EFFECT OF LED LAMPS

(71) Applicant: SHENZHEN SUNMOON MICROELECTRONICS CO., LTD., Shenzhen (CN)

(72) Inventor: Zhaohua Li, Shenzhen (CN)

(21) Appl. No.: 17/569,736

(22) Filed: Jan. 6, 2022

(30) Foreign Application Priority Data
Mar. 9, 2021 (CN) 202110256113.8

(51) Int. Cl. G09G 3/32; H05B 45/20

(52) U.S. Cl. CPC G09G 3/32; H05B 45/20; G09G 2320/0271; G09G 2310/0264

(57) ABSTRACT

The present application relates to a method and device for improving gradient effect of LED lamps. The method comprises: S1. decoding an input signal to obtain display grayscale data; S2. dynamically adjusting a frame number of transition frames according to a frame interval time; S3. calculating a transition frame step value according to the frame number of transition frames, the display grayscale data of the previous frame and the current frame; and S4. at a time point of frame change, switching the display grayscale data according to the transition frame step value, a transition frame step time, the display grayscale data of the previous frame and the current frame. According to embodiments of the present application, brightness difference between data of the previous frame and the current frame at the time point of frame change is reduced, and the gradient display effect of LED lamps is improved.

### CROSS-REFERENCE TO RELATED APPLICATIONS

The present application claims the benefit of Chinese Patent Application No. 202110256113.8 filed on Mar. 9, 2021. All the above are hereby incorporated by reference.

### FIELD

The present application relates to LED (light-emitting diode) display technologies, and in particular, to a method and device for improving gradient effect of LED lamps.

### BACKGROUND

With continuous development of LED lighting display technologies, LED lighting products have been widely used in stage lighting, urban landscape lighting and such other fields due to their advantages of long service life, energy saving, environmental protection, and pure color. The whole society has an increasing demand for LED lighting. In traditional LED lighting applications, a received 256-level grayscale data is usually corrected by a 65536-level gamma correction to obtain a better display effect. However, in order to meet a high-brightness requirement of some occasions, high-power lamps are usually used. Due to an overall increase in brightness, even in a low gray grade, a brightness difference between two adjacent grayscale data after being gamma-corrected is also easy to be captured by human eyes. This causes when a light is gradually displayed, the human eyes will feel the light jitter slightly, which affects the display effect.

### SUMMARY

The purpose of the present application is to provide a method and device for improving gradient effect of LED lamps, so as to solve the problem of slight jitter when the lamps are gradually displayed.

According to a first aspect of the present application, a method for improving gradient effect of LED lamps is provided, comprising the following steps:

S1. Decoding an input signal to obtain display grayscale data;

S2. Dynamically adjusting a frame number of transition frames according to a frame interval time;

S3. Calculating a transition frame step value according to the frame number of transition frames, the display grayscale data of the previous frame, and the display grayscale data of the current frame; and

S4. At a time point of frame change, switching the display grayscale data according to the transition frame step value, a transition frame step time, the display grayscale data of the previous frame, and the display grayscale data of the current frame.

According to an embodiment of the method for improving gradient effect of LED lamps of the present application, in the step S2, the number of transition frames=the frame interval time/the transition frame step time, that is:

n=T/t,

wherein n denotes the number of transition frames, T denotes the frame interval time, and t denotes the transition frame step time.

According to an embodiment of the method for improving gradient effect of LED lamps of the present application, in the step S3, the transition frame step value is calculated by

s=|x−y|/n,

wherein s denotes the transition frame step value, x denotes the display grayscale data of the previous frame, y denotes the display grayscale data of the current frame, and n denotes the number of transition frames.

According to an embodiment of the method for improving gradient effect of LED lamps of the present application, in the step S4, the display grayscale data is displayed according to a rule of data of the previous frame→data of a first transition frame→data of a second transition frame→ . . . →data of a nth transition frame→data of the current frame.

According to an embodiment of the method for improving gradient effect of LED lamps of the present application, the method further comprises:

S5. Outputting a PWM signal according to the switched display grayscale data.

According to a second aspect of the present application, a device for improving gradient effect of LED lamps is provided, comprising:

a data decoding module, configured to decode an input signal to obtain display grayscale data;

a frame interval calculation module, configured to calculate an interval time of data between a previous frame and a current frame, and dynamically adjust a frame number of transition frames according to the interval time;

a data buffer unit for current frame, configured to buffer the display grayscale data of the current frame;

a data buffer unit for previous frame, configured to buffer the display grayscale data of the previous frame;

a buffer unit for transition frame step value, configured to calculate and buffer a transition frame step value according to the frame number of transition frames, the display grayscale data of the previous frame, and the display grayscale data of the current frame; and

a display grayscale data switching module, configured to switch the display grayscale data according to the transition frame step value, a transition frame step time, the display grayscale data of the previous frame and the display grayscale data of the current frame at a time point of frame change.

According to an embodiment of the device for improving gradient effect of LED lamps of the present application, the number of transition frames=the frame interval time/the transition frame step time, that is:

n=T/t,

wherein n denotes the number of transition frames, T denotes the frame interval time, and t denotes the transition frame step time.

According to an embodiment of the device for improving gradient effect of LED lamps of the present application, the transition frame step value is calculated by

s=|x−y|/n,

wherein s denotes the transition frame step value, x denotes the display grayscale data of the previous frame, y denotes the display grayscale data of the current frame, and n denotes the number of transition frames.

According to an embodiment of the device for improving gradient effect of LED lamps of the present application, the display grayscale data is displayed according to a rule of data of the previous frame→data of a first transition frame→data of a second transition frame→ . . . →data of a nth transition frame→data of the current frame.

According to an embodiment of the device for improving gradient effect of LED lamps of the present application, the device further comprises:

a PWM output module, configured to output a PWM signal according to the switched display grayscale data.

According to a third aspect of the present application, an LED display device is provided, comprising at least one processor and a memory communicatively connected with the at least one processor, wherein the memory stores instructions that are executable for the at least one processor, and the instructions are executed by the at least one processor so at to cause the at least one processor executing the method for improving gradient effect of an LED lamps as described above.

According to a fourth aspect of the present application, a non-transitory computer-readable storage medium, wherein the non-transitory computer-readable storage medium stores computer instructions, and the computer instructions are executed to cause a computer to execute the method for improving gradient effect of LED lamps as described above.

Implementation of the embodiments of the present application has the following beneficial effects: with the method and device for improving gradation effect of LED lamps provided by the present application, data of the transition frames of the previous frame and the current frame is firstly displayed at the time point of frame change when new grayscale data is received, and then a switching to the display data of the current frame is performed, so that the frame change process is smooth transition process, thereby brightness difference between data of the previous frame and the current frame at the time point of frame change is reduced, causing a brightness curve of gradient display being smoother. Accordingly, the brightness difference of the frame change that is easily captured by human eyes when low grayscale gradient is displayed is avoided, and the gradient display effect of LED lamps is improved.

### BRIEF DESCRIPTION OF THE DRAWINGS

In order to explain the embodiments of the present application or the technical solutions in the prior art more clearly, the following will briefly introduce drawings that need to be used in the description of the embodiments or the prior art. Obviously, the drawings in the following description only show some embodiments of the present application. For those of ordinary skill in the art, other drawings can be obtained based on these drawings without creative work. In the accompanying drawings:

FIG. 1 is a flowchart of a method for improving gradient effect of LED lamps according to an embodiment of the present application;

FIG. 2 is a schematic diagram of display data switching in Step S4 as shown in FIG. 1;

FIG. 3 is a display effect diagram according to a method for improving gradient effect of LED lamps of an embodiment of the present application;

FIG. 4 is a schematic diagram of a device for improving gradient effect of LED lamps according to an embodiment of the present application;

FIG. 5 is a schematic diagram of an LED display device according to an embodiment of the present application.

### DETAILED DESCRIPTION

The technical solutions in the embodiments of the present application will be clearly and completely described below in conjunction with the accompanying drawings in the embodiments of the present application. Obviously, the described embodiments are only a part of the embodiments of the present application, rather than all the embodiments. Based on the embodiments of the present application, all other embodiments obtained by those of ordinary skill in the art without creative work shall fall within the protection scope of the present application.

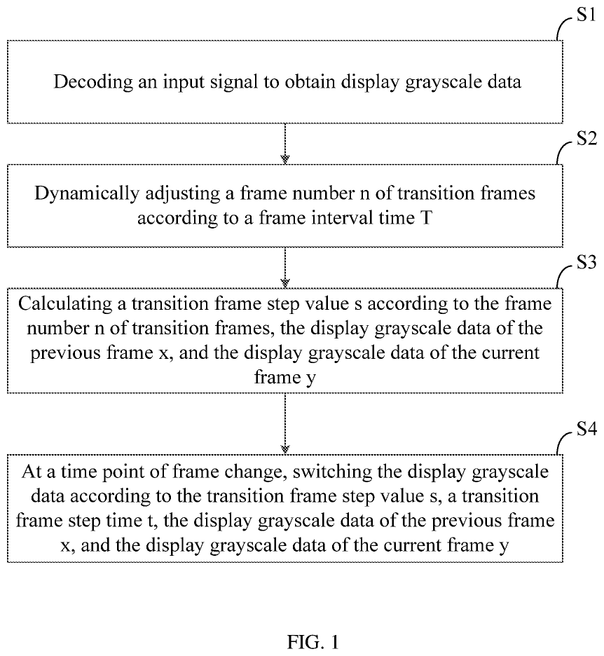

FIG. 1 is a flowchart of a method for improving gradient effect of LED lamps according to an embodiment of the present application. As shown in FIG. 1, the method for improving gradient effect of LED lamps provided by the present application comprises the following steps:

Step S1. Decoding an input signal to obtain display grayscale data.

Step S2. Dynamically adjusting a frame number n of transition frames according to a frame interval time T.

Specifically, in an embodiment of the present application, an interval time between the display grayscale data of a previous frame and the display grayscale data of a current frame is detected, denoted as T, and the frame number of transition frames is dynamically adjusted according to T and a transition frame step time t (4 ms in this embodiment), denoted as n, n=T/t.

Step S3. Calculating a transition frame step value s according to the frame number n of transition frames, the display grayscale data of the previous frame x, and the display grayscale data of the current frame y.

Specifically, in an embodiment of the present application, the display grayscale data of the previous frame is denoted as x, and the display grayscale data of the current frame is denoted as y, and both of them are buffered separately, and an absolute value of a difference between the two display grayscale data is calculated, denoted as |x−y|. The frame number of transition frames is denoted as n, and a value of n will be dynamically adjusted according to a value of T. The transition frame step value is denoted as s, with s=|x−y|/n, and the transition frame step value s is buffered in a buffer unit for transition frame step value.

Step S4. At a time point of frame change, switching the display grayscale data according to the transition frame step value s, the transition frame step time t, the display grayscale data of the previous frame x, and the display grayscale data of the current frame y.

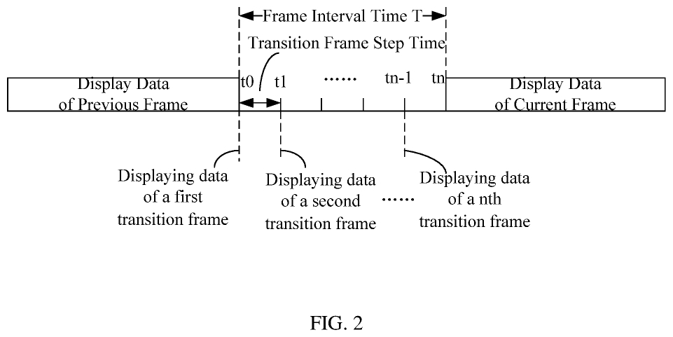

Specifically, in an embodiment of the present application, as shown in FIG. 2, a time at the time point of frame change is denoted as t0, and the display data is displayed according to a rule of data of the previous frame→data of a first transition frame→data of a second transition frame→ . . . →data of a nth transition frame→data of the current frame.

Further, a data display process of the transition frames is as follows:

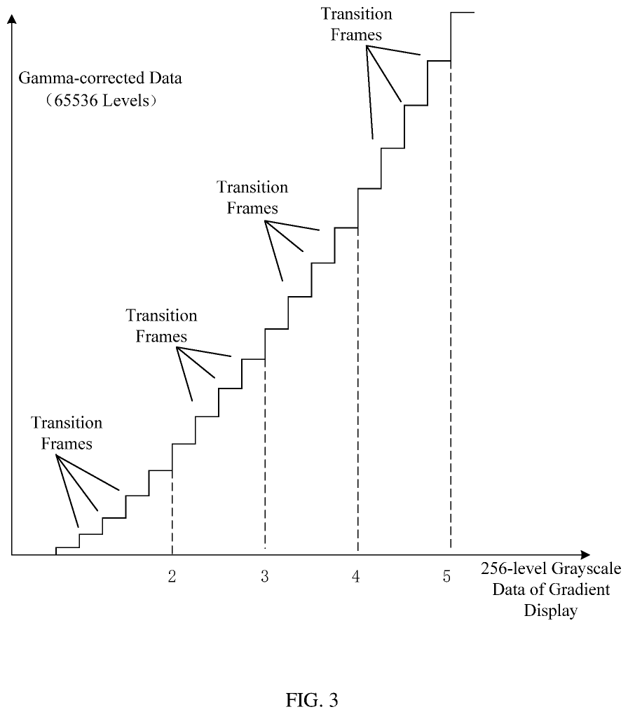

At the time point of frame change t0, data of the first transition frame is displayed, and its value is x±s, that is, data of the previous frame plus/minus a step value, wherein plus or minus is determined based on data of the previous frame and data of the current frame; after a transition frame step time t has elapsed, a current time point is recorded as t1, t1=t0+t, and data of the second transition frame is displayed, and its value is x±s*2; and so on, data of the transition frame displayed at a time point to is x±s*n. In an embodiment of the present application, in order to ensure that a value after n times of accumulation or subtraction is equal to data value of the current frame, the value of s is adjusted by a compensation algorithm. In the other embodiment of the present application, when the value after n times of accumulation or subtraction exceeds data value of the current frame, the display data is always set as data of the current frame. It can be seen from FIG. 3 that step phenomenon is not obvious in a gradient curve after the transition frames are inserted at the time point of frame change.

Step S5. Outputting a PWM signal according to the switched display grayscale data.

With the method for improving gradation effect of LED lamps provided by the present application, data of the transition frames of the previous frame and the current frame is firstly displayed at the time point of frame change when new grayscale data is received, and then a switching to the display data of the current frame is performed, so that the frame change process is smooth transition process, thereby brightness difference between data of the previous frame and the current frame at the time point of frame change is reduced, causing a brightness curve of gradient display being smoother. Accordingly, the brightness difference of the frame change that is easily captured by human eyes when low grayscale gradient is displayed is avoided, and the gradient display effect of LED lamps is improved.

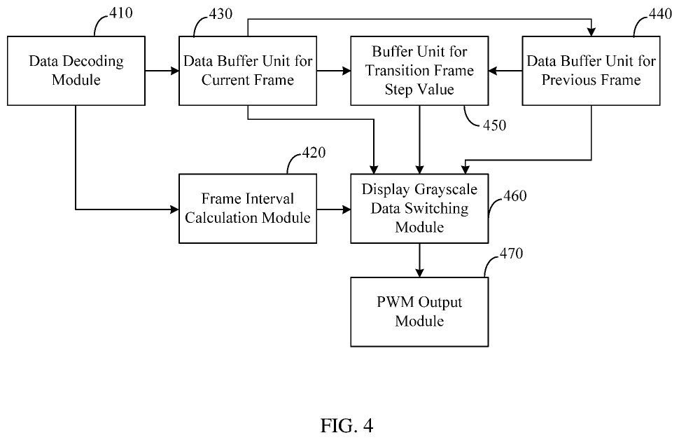

Referring to FIG. 4, based on the same inventive concept, a device for improving gradient effect of LED lamps is provided according to an embodiment of the present application, comprising a data decoding module 410, a frame interval calculation module 420, a data buffer unit for current frame 430, a data buffer unit for previous frame 440, a buffer unit for transition frame step value 450, a display grayscale data switching module 460, and a PWM output module 470. The data decoding module 410 is configured to decode an input signal to obtain display grayscale data. The frame interval calculation module 420 is configured to calculate an interval time of data between a previous frame and a current frame, and dynamically adjust a frame number n of transition frames according to the interval time. Specifically, in an embodiment of the present application, the interval time between the display grayscale data of the previous frame and the display grayscale data of the current frame is detected, denoted as T, and the frame number of transition frames is dynamically adjusted according to T and a transition frame step time t (4 ms in this embodiment), denoted as n, n=T/t. The data buffer unit for current frame 430 is configured to buffer the display grayscale data of the current frame y, and the data buffer unit for previous frame 440 is configured to buffer the display grayscale data of the previous frame x. The buffer unit for transition frame step value 450 is configured to calculate and buffer a transition frame step value s according to the frame number n of transition frames, the display grayscale data of the previous frame x, and the display grayscale data of the current frame y. Specifically, in an embodiment of the present application, the display grayscale data of the previous frame is denoted as x, and the display grayscale data of the current frame is denoted as y, and both of them are buffered separately, and an absolute value of a difference between the two display grayscale data is calculated, denoted as |x−y|. The frame number of transition frames is denoted as n, and a value of n will be dynamically adjusted according to a value of T. The transition frame step value is denoted as s, with s=|x−y|/n, and the transition frame step value s is buffered in the buffer unit for transition frame step value 450. The display grayscale data switching module 460 is configured to switch the display grayscale data according to the transition frame step value s, the transition frame step time t, the display grayscale data of the previous frame x, and the display grayscale data of the current frame y at a time point of frame change. Specifically, in an embodiment of the present application, a time at the time point of frame change is denoted as t0, and the display data is displayed according to a rule of data of the previous frame→data of a first transition frame→data of a second transition frame→ . . . →data of a nth transition frame→data of the current frame. The PWM output module 470 is configured to output a PWM signal according to the switched display grayscale data.

Further in an embodiment of the present application, a data display process of the transition frames is as follows:

At the time point of frame change t0, data of the first transition frame is displayed, and its value is x±s, that is, data of the previous frame plus/minus a step value, wherein plus or minus is determined based on data of the previous frame and data of the current frame; after a transition frame step time t has elapsed, a current time point is recorded as t1, t1=t0+t, and data of the second transition frame is displayed, and its value is x±s*2; and so on, data of the transition frame displayed at a time point to is x±s*n. In an embodiment of the present application, in order to ensure that a value after n times of accumulation or subtraction is equal to data value of the current frame, the value of s is adjusted by a compensation algorithm. In the other embodiment of the present application, when the value after n times of accumulation or subtraction exceeds data value of the current frame, the display data is always set as data of the current frame. It can be seen from FIG. 3 that step phenomenon is not obvious in a gradient curve after the transition frames are inserted at the time point of frame change.

Function of each functional module described in the device embodiment of the present application can be specifically implemented according to the method in the foregoing method embodiment, and a specific implementation process can refer to the relevant description of the foregoing method embodiment, which will not be repeated here.

It should be pointed out that in the above description of the various modules, division into these modules is for clarity of illustration. However, in actual implementation, boundaries of various modules may be blurred. For example, any or all functional modules in this document can share various hardware and/or software elements. For another example, any and/or all functional modules in this document may be implemented in whole or in part by executing software instructions by a common processor. In addition, various software sub-modules executed by one or more processors can be shared among various software modules. Accordingly, unless expressly required, the scope of the present application is not limited by mandatory boundaries between various hardware and/or software elements.

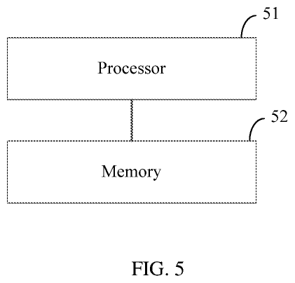

FIG. 5 is a schematic diagram of hardware structure of an LED display device according to an embodiment of the present application. As shown in FIG. 5, the LED display device comprises one or more processors 51 and a memory 52. In FIG. 5, one processor 51 is taken as an example. The processor 51 and the memory 52 may be connected via a bus or in other ways, such as connection via a bus in FIG. 4.

The processor 51 can be a central processing unit (CPU). The processor 51 can also be other general-purpose processor, a digital signal processor (DSP), an application specific integrated circuit (ASIC), a field-programmable gate array (FPGA) or other programmable logic devices, discrete gates or transistor logic devices, discrete hardware components and other chips, or a combination of the above types of chips. The general-purpose processor may be a microprocessor or the processor may also be any conventional processor or the like.

The memory 52, as a non-transitory computer-readable storage medium, can be configured to store non-transitory software programs, non-transitory computer executable programs, and modules, such as the program instructions/modules corresponding to the method for improving gradient effect of LED lamps according to the embodiments of the present application. The processor 51 executes various functional applications and data processing of the server by running the non-transitory software programs, instructions and modules stored in the memory 52, so as to realize the method for improving gradient effect of the LED lamps according to the above-described embodiments of the present application.

The memory 52 may comprises a program storage area and a data storage area. The program storage area is configured to store an operating system and application program required by at least one function. The data storage area is configured to store data created according to the use of the device for improving gradation effect of LED lamps. In addition, the memory 52 may comprises a high-speed random access memory, and may also comprise a non-transitory memory, such as at least one magnetic disk storage device, a flash memory device, or other non-transitory solid-state storage devices. In some embodiments, the memory 52 may optionally comprises a memory remotely provided with respect to the processor 51, and these remote memories may be connected to the device for improving gradation effect of LED lamps via a network. Examples of the aforementioned networks include, but are not limited to, internet, corporate intranets, local area networks, mobile communication networks, and combinations thereof.

The one or more modules are stored in the memory 52, and when executed by the one or more processors 51, the method for improving gradient effect of LED lamps as described above is executed.

The above-mentioned products can execute the methods provided in the embodiments of the present application, and have corresponding functional modules and beneficial effects for executing the methods. For technical details that are not described in detail in this embodiment, for details, please refer to the relevant description in the embodiment shown in FIG. 1.

According to an embodiment of the present application, a non-transitory computer-readable storage medium is provided, the storage medium storing computer-executable instructions, and the computer-executable instructions can execute the method for improving gradient effect of LED lamps as described above. The storage medium may be a magnetic disk, an optical disc, a read-only memory (ROM), a random access memory (RAM), a flash memory, a hard disk (HDD) or a solid-state drive (SSD), etc. The storage medium may also comprise a combination of the foregoing types of memories.

Those skilled in the art can understand that all or part of the processes in the above-mentioned method embodiments can be implemented by instructing relevant hardware through a computer program. The program can be stored in a computer-readable storage medium. Execution of the program may include the processes of the above-mentioned method embodiments. Wherein, the storage medium can be a magnetic disk, an optical disc, a read-only memory (ROM) or a random access memory (RAM), etc.

Although the embodiments of the present application have been described with reference to the accompanying drawings, those skilled in the art can make various modifications and variations without departing from the spirit and scope of the present application, and such modifications and variations fall within the scope defined by the appended claims.

1. A method for improving gradient effect of LED lamps, comprising the following steps:
S1. Decoding an input signal to obtain display grayscale data;
S2. Dynamically adjusting a frame number of transition frames according to a frame interval time;
S3. Calculating a transition frame step value according to the frame number of transition frames, the display grayscale data of the previous frame, and the display grayscale data of the current frame; and
S4. At a time point of frame change, switching the display grayscale data according to the transition frame step value, a transition frame step time, the display grayscale data of the previous frame, and the display grayscale data of the current frame.

2. The method for improving gradient effect of LED lamps according to claim 1, wherein in the step S2, the number of transition frames=the frame interval time/the transition frame step time, that is:
n=T/t,
wherein n denotes the number of transition frames, T denotes the frame interval time, and t denotes the transition frame step time.

3. The method for improving gradient effect of LED lamps according to claim 2, wherein in the step S3, the transition frame step value is calculated by
s=|x−y|/n,
wherein s denotes the transition frame step value, x denotes the display grayscale data of the previous frame, y denotes the display grayscale data of the current frame, and n denotes the number of transition frames.

4. The method for improving gradient effect of LED lamps according to claim 1, wherein in the step S4, the display grayscale data is displayed according to a rule of data of the previous frame→data of a first transition frame→data of a second transition frame→ . . . →data of a nth transition frame→data of the current frame.

5. The method for improving gradient effect of LED lamps according to claim 1, wherein the method further comprises:
S5. Outputting a PWM signal according to the switched display grayscale data.

6. A device for improving gradient effect of LED lamps, comprising:
a data decoding module, configured to decode an input signal to obtain display grayscale data;
a frame interval calculation module, configured to calculate an interval time of data between a previous frame and a current frame, and dynamically adjust a frame number of transition frames according to the interval time;
a data buffer unit for current frame, configured to buffer the display grayscale data of the current frame;
a data buffer unit for previous frame, configured to buffer the display grayscale data of the previous frame;
a buffer unit for transition frame step value, configured to calculate and buffer a transition frame step value according to the frame number of transition frames, the display grayscale data of the previous frame, and the display grayscale data of the current frame; and
a display grayscale data switching module, configured to switch the display grayscale data according to the transition frame step value, a transition frame step time, the display grayscale data of the previous frame and the display grayscale data of the current frame at a time point of frame change.

7. The device for improving gradient effect of LED lamps according to claim 6, wherein the number of transition frames=the frame interval time/the transition frame step time, that is:
n=T/t,
wherein n denotes the number of transition frames, T denotes the frame interval time, and t denotes the transition frame step time.

8. The device for improving gradient effect of LED lamps according to claim 7, wherein the transition frame step value is calculated by
s=|x−y|/n,
wherein s denotes the transition frame step value, x denotes the display grayscale data of the previous frame, y denotes the display grayscale data of the current frame, and n denotes the number of transition frames.

9. The device for improving gradient effect of LED lamps according to claim 6, wherein the display grayscale data is displayed according to a rule of data of the previous frame→data of a first transition frame→data of a second transition frame→ . . . →data of a nth transition frame→data of the current frame.

10. The device for improving gradient effect of LED lamps according to claim 6, wherein the device further comprises:
a PWM output module, configured to output a PWM signal according to the switched display grayscale data.

11. An LED display device, comprising at least one processor and a memory communicatively connected with the at least one processor, wherein the memory stores instructions that are executable for the at least one processor, and the instructions are executed by the at least one processor so at to cause the at least one processor executing the method for improving gradient effect of an LED lamps according to claim 1.

12. A non-transitory computer-readable storage medium, wherein the non-transitory computer-readable storage medium stores computer instructions, and the computer instructions are executed to cause a computer to execute the method for improving gradient effect of LED lamps according to claim 1.
